(19) United States
(12) Patent Application Publication
(10) Pub. No.: US 2024/0009946 A1
(43) Pub. Date: Jan. 11, 2024

(54) APPARATUS, SYSTEM AND METHOD FOR THE REMOVAL OF AN OPHTHALMIC LENS FROM A LENS TREATMENT CONTAINER

(71) Applicant: Alcon Inc., Fribourg (CH)

(72) Inventors: Felix Brinckmann, Roßdorf (DE); Nils Schweizer, Bad König (DE)

(21) Appl. No.: 18/346,904

(22) Filed: Jul. 5, 2023

Related U.S. Application Data
(60) Provisional application No. 63/367,881, filed on Jul. 7, 2022.

(51) Int. Cl. B29D 11/00

(52) U.S. Cl. CPC B29D 11/0024

(57) ABSTRACT

An apparatus for removal of an ophthalmic lens, such as a contact lens, for example a soft contact lens, from a lens treatment container for the accommodation of the ophthalmic lens during a lens treatment process, comprises:
an exhaust air box comprising
   at least one inlet for allowing ambient air to be drawn into the exhaust box;
   an outlet in fluid communication with the exhaust air box, the outlet capable of being connected to a source of negative pressure;
at least one tube having a proximal end connected to the at least one inlet of the exhaust air box, and a distal end having a displaceable nozzle; and
an actuator connected to the nozzle, for displacing the nozzle from a standby position to a lens removal position, and back to the standby position.

### FIELD OF INVENTION

The invention relates to an apparatus, a system and a method for removal of an ophthalmic lens, such as a contact lens, for example a soft contact lens, from a lens treatment container for the accommodation of the ophthalmic lens during a lens treatment process.

### BACKGROUND

In the automated production of ophthalmic lenses, in particular contact lenses such as soft contact lenses, it is well established to produce the soft contact lenses in an automated production process with reusable molds. Depending on the material used for producing the lens and in accordance with the production process, the lens is immersed in certain treatment liquids, for example extraction liquids and/or rinsing liquids and/or coating liquids, in order to obtain the final soft contact lens which may be worn in direct contact with the consumer's eye. During such lens treatment process, the contact lens is accommodated in a lens treatment container in which the lens is safely retained during its exposure to the treatment liquids. Once the lens treatment process is complete, the lens is removed from the lens treatment container, and the lens treatment container is subsequently returned for being re-used in the production process to accommodate a new contact lens, for example in a subsequent cycle of the lens treatment process. The contact lens is removed from the lens treatment container at a lens transfer station while the lens treatment container is still arranged in a liquid environment, e.g. by means of a suitable gripper, and is then transferred to subsequent stations in the production process, such as lens inspection stations. And although this is a highly reliable and repeatable production process, there may be occurrences in which the contact lens is not successfully removed from the lens treatment container by the gripper, but may remain in the lens treatment container. Consequently, when the lens treatment container is returned for being re-used the lens is still in the lens treatment container although the lens treatment container should be empty. Accordingly, once the next lens is introduced into the lens treatment container for treatment, there are two lenses contained in the lens treatment container. Once the lens treatment container containing the two lenses arrives at the lens transfer station, the gripper may transfer both lenses contained in the lens treatment container into an inspection receptacle in which the lenses are subsequently inspected. The presence of two lenses is then detected during the lens inspection, and the two lenses must both be disposed of even though they have the same optical properties, since it is unclear which one of the two lenses has been exposed to the treatments liquids twice and which one of the two lenses has been exposed to the treatment liquids only once. Obviously, this has adverse effects on the yield.

It is therefore an object of the invention to overcome the afore-discussed disadvantages and to suggest suitable measures to make sure the lens treatment container is empty (no lens in the lens treatment container anymore) at the time the lens treatment container is ready for being re-used, i.e. at the time the lens treatment container is ready for accommodating the next lens to be treated.

### SUMMARY

According to the invention, this object is met by an apparatus for the removal of an ophthalmic lens from a container for the accommodation thereof during a lens treatment process, as specified in independent claim 1. Further advantageous aspects of the apparatus according to the invention are the subject of the dependent claims directed to the apparatus.

In particular, in accordance with the invention an apparatus for the removal of an ophthalmic lens, such as a contact lens, for example a soft contact lens, from a container for the accommodation thereof during a lens treatment process is provided. The apparatus comprises an exhaust air box comprising at least one inlet for allowing ambient air to be drawn into the exhaust box, and an outlet in fluid communication with the exhaust air box, the outlet capable of being connected to a source of negative pressure. The apparatus further comprises at least one tube having a proximal end connected to the at least one inlet of the exhaust air box, and a distal end having a displaceable nozzle. Yet further, the apparatus comprises an actuator connected to the nozzle, for displacing the nozzle from a standby position to a lens removal position, and back to the standby position.

According to one aspect of the apparatus according to the invention, the exhaust air box may further comprise a shutter configured to open or close the at least one inlet of the exhaust air box to establish or interrupt a fluid communication between the nozzle and the exhaust air box.

According to a further aspect of the apparatus according to the invention, the exhaust air box may comprise a lens retainer arranged in an interior space of the exhaust air box.

According to still a further aspect of the apparatus according to the invention, the apparatus may further comprise a supply tube connected to the outlet of the exhaust air box and capable of being connected to the source of negative pressure, and a pitot pipe sensor arranged in the supply tube for determining a flow of exhaust air through the supply tube.

According to a further aspect of the apparatus according to the invention, the exhaust air box may further comprise a vacuum gauge arranged in fluid communication with an interior space of the exhaust air box, for determining a negative pressure in the interior space of the exhaust air box.

According to another aspect of the apparatus according to the invention, the at least one tube may be a flexible tube.

According to a further aspect of the apparatus according to the invention, the apparatus may further comprise an air flow directing element. The air flow directing element comprises a base plate having an upper surface. The air flow directing element further comprises at least one pair of air directing walls extending away from the upper surface of the base plate in a direction perpendicular thereto and being arranged parallel to one another to define an air guiding channel therebetween which is sized to allow a lens treatment container to be moved into the air guiding channel for the removal of the ophthalmic lens from the lens treatment container.

According to still a further aspect of the apparatus according to the invention, the exhaust air box may comprise a plurality of inlets, and the apparatus may comprise a corresponding plurality of tubes, with each tube of the corresponding plurality of tubes being connected to a respective inlet of the plurality of inlets of the exhaust air box. The air flow directing element may comprise a corresponding plurality of air guiding channels being arranged parallel to one another to allow a corresponding plurality of lens treatment containers to be concurrently moved into the corresponding plurality of air guiding channels, one lens treatment container of the corresponding plurality of lens treatment containers into one air guiding channel of the corresponding plurality of air guiding channels.

According to yet a further aspect of the apparatus according to the invention, the apparatus may further comprise an elongated web, wherein the nozzles of the plurality of tubes are all connected to the web in an arrangement corresponding to the arrangement of the air guiding channels of the air flow directing element. The actuator may be connected to the web for displacing the web to concurrently displace all nozzles from the standby position to the lens removal position, and back to the standby position.

According to another aspect of the apparatus according to the invention, the apparatus may further comprise a corresponding plurality of shutters, one shutter of the corresponding plurality of shutters for one inlet of the plurality of inlets of the exhaust air box. The apparatus may further be configured to concurrently open and close a predetermined number of shutters of the corresponding plurality of shutters to open and close a corresponding predetermined number of inlets of the plurality of inlets of the exhaust air box.

Further in accordance with the invention, a system for removal of an ophthalmic lens, such as a contact lens, for example a soft contact lens, from a lens treatment container for the accommodation of the ophthalmic lens during a lens treatment process is provided. The system comprises an apparatus according to the invention for the removal of an ophthalmic lens from the lens treatment container, as described above, and a source of negative pressure connected to the outlet of the exhaust air box. The system further comprises at least one lens treatment container for the accommodation of an ophthalmic lens during a lens treatment process. Still further, the system comprises a transport mechanism for transporting the at least one lens treatment container to and from the apparatus for the removal of the ophthalmic lens from the at least one lens treatment container. The system is configured such that in the apparatus for the removal of the ophthalmic lens from the lens treatment container the at least one lens treatment container is arranged in an air environment.

According to one aspect of the system according to the invention, the at least one lens treatment container may comprise a substantially tubular body. The body has an open end defining an access opening which is in fluid communication with an interior space of the body, and the body further has openings therein for allowing fluid communication between an exterior of the lens treatment container and the interior space of the body. The nozzle comprises a distal nozzle end sized and shaped for introduction into the lens treatment container through the access opening to establish a fluid communication of the nozzle and the interior space of the body.

Further in accordance with the invention, a method for removal of an ophthalmic lens, such as a contact lens, for example a soft contact lens, from a lens treatment container for the accommodation of the ophthalmic lens during a lens treatment process is provided. The method comprises: providing an apparatus according to the invention as described above or a system according to the invention as described above; supplying negative pressure to the outlet of the exhaust air box of the apparatus to provide suction at the inlet of the exhaust air box; providing a lens treatment container for the accommodation of an ophthalmic lens during a lens treatment process; and operating the actuator of the apparatus to displace the nozzle from the standby position to the lens removal position to establish a fluid communication between the inlet of the apparatus and an interior space of the lens treatment container, thereby applying the suction at the inlet of the exhaust air box to the interior space of the lens treatment container.

The invention has a number of advantages.

In the following, whenever the term ‘lens’ is used, this term is to be understood to denote an ophthalmic lens, such as a contact lens, and in particular includes a soft contact lens. With the aid of the apparatus according to the invention the lens is removed from the lens treatment container even in cases in which the lens inadvertently remains in the lens treatment container at the transfer station (from where is should normally be transferred to an inspection receptacle). Thus, it is made sure the lens treatment container is empty at the time it is re-used (i.e. at the time of accommodating the next lens to be treated in the lens treatment container). Unnecessary disposal of lenses due to two (or even more) lenses being concurrently transferred into an inspection receptacle, as discussed further above, can thus be avoided, thus increasing the yield.

With the aid of the actuator connected to the displaceable nozzle, the nozzle may conveniently be displaced from a standby position, in which the nozzle is arranged at a location spaced from the lens treatment container so that there is no fluid communication between the nozzle and the interior of the lens treatment container where the lens is contained, to a lens removal position, in which the nozzle is arranged in fluid communication with the interior of the lens treatment container such that a lens can be removed from the lens treatment container by the negative pressure applied through the nozzle, and back to the standby position.

The position of the nozzle, in particular the position of the distal end of the nozzle, may be monitored through any suitable position monitoring means. For example, the position monitoring means may comprise a sensor, such as a proximity sensor, in particular a proximity switch. The actuator may be configured to displace the nozzle by means of a linear movement.

For example, the actuator may comprise a pneumatic cylinder, thereby providing a simple and reliable means for linearly moving the nozzle from the standby position to the lens removal position, and back to the standby position.

The apparatus according to the invention may be readily implemented in a fully automated production line for producing ophthalmic lenses. For example, the apparatus may be arranged at a location in the return path of the lens treatment container from the transfer station (where the lens is transferred from the lens treatment container to the inspection receptacle) to the location where the next lens is introduced into and accommodated in the lens treatment container for subsequent treatment.

The provision of a shutter is advantageous with respect to reduce energy consumption, as the air flow for sucking the lens out of the lens treatment container does not have to be continuously maintained. Thus, during the period when the shutter is closed (and this is the case for most of the time) only the predetermined vacuum in the exhaust air box must be maintained, however, without the need to maintain the air flow. In addition, at the time of opening the shutter, the air flow generated at the nozzle may be higher when compared to an apparatus having no shutters (i.e. when the air flow is continuously maintained), thus improving the removal of the lens from the lens treatment container.

The shutter may comprise a pneumatic cylinder configured to operate the shutter to open or close the at least one inlet of the exhaust air box by means of a linear movement. Pneumatic cylinders are very reliable and can be readily integrated into an automated production line in which compressed air is generally available.

The position of the shutter, such as an open position or a closed position, may advantageously be monitored by a position monitoring means. The position monitoring means may comprise one or more sensors, such as a proximity sensor, in particular a proximity switch.

By providing a lens retainer in an interior space of the exhaust air box, the removed contact lens may be conveniently collected in the lens retainer, and the lens retainer can be emptied from time to time. For example, the lens retainer may comprise a perforated metal pan arranged in the interior space of the exhaust air box, which may be accessible by means of a sealed maintenance door. The position of the maintenance door may be monitored by means of a sensor, such as a proximity switch, in order to make sure the maintenance door is properly closed again once the lens retainer has been emptied and placed back into the interior space of the exhaust air box.

By providing a pitot pipe sensor in a supply tube connected to the outlet of the exhaust air box, it is possible to monitor whether there is sufficient flow in the supply tube, for example when the shutter is open. A flow that is lower than a predetermined threshold flow in the supply tube may be an indication that either insufficient negative pressure is supplied, or may be indicative of a blockage (e.g. due to clogging) of the flow through the apparatus.

The provision of a vacuum gauge arranged in fluid communication with an interior space of the exhaust air box to determine the negative pressure in the interior space allows for the detection of an unwanted leakage. An unwanted leakage may lead to an insufficient flow through the lens treatment container during lens removal so that instead of being removed from the lens treatment container the lens may be retained therein.

A combination of both the vacuum gauge and the pitot pipe sensor as discussed above is particularly advantageous, since it is possible to monitor on one hand that sufficient vacuum is present in the interior space of the air box while at the same time it is possible to monitor that the air flow is sufficient to reliably remove the lens (if present) from the lens treatment container.

In case the tube the proximal end of which is connected to the inlet of the exhaust air is a flexible tube this provides for an easy and inexpensive solution for displaceable nozzle, as it is only necessary to displace distal end of the flexible tube that has the nozzle. It is thus possible to arrange the rest of the apparatus—in particular the exhaust air box—at a fixed position. By way of example, the exhaust air box may be fixedly mounted above a return path along which the lens treatment container is transported back to a position in which it accommodates the next lens to be treated, this return path passing beneath the nozzle at the distal end of the flexible tube (nozzle is in the standby position). Once the lens treatment container reaches a position beneath the nozzle when being transported along the return path, it is only necessary to interrupt transportation of the lens treatment container along the return path for a predetermined time, and to lower the distal end of the flexible tube by a predetermined distance to introduce the nozzle into the lens treatment container (lens removal position) to establish a fluid communication between the nozzle and the interior of the lens treatment container. In case a shutter is present, the shutter may then be opened to allow the lens to be removed from the lens treatment container by the air flow caused by the application of suction through the nozzle. After lens removal is completed, the nozzle is raised again by the same predetermined distance back to the standby position, whereupon transportation of the lens treatment container along the return path may be resumed.

The provision of an air flow directing element having a base plate that has an upper surface and a pair of air directing walls extending away from the upper surface of the base plate in a direction perpendicular to this upper surface and parallel to one another is particularly beneficial for the safe removal of a contact lens from the lens treatment container. The afore-describe arrangement defines an air guiding channel extending through the pair of walls, and this air guiding channel is sized to allow a lens treatment container to be moved (transported) into the air guiding channel for the removal of the lens from the lens treatment container. With the lens treatment container being arranged in the air guiding channel during lens removal, the directed air flow caused by the air guiding channel (i.e. the flow in the direction of the air guiding channel defined by the pair of walls) leads to an improved removal of the lens from the lens treatment container.

The apparatus may further be capable of simultaneously removing a plurality of lenses from a plurality of lens treatment containers. For that purpose, the exhaust air box may comprise a plurality of inlets, and the apparatus may comprise corresponding plurality of tubes, with each tube of the corresponding plurality of tubes being connected to a respective inlet of the plurality of inlets of the exhaust air box. For example, the exhaust air box comprises a number in the range of ten to twenty inlets, in particular fourteen to sixteen inlets, and a corresponding number of tubes. Thereby, aspects of the invention provide an efficient solution for removal of contacts lenses from a plurality of lens treatment containers. Also, a corresponding number of air guiding channels is provided which are arranged parallel to one another to allow a corresponding plurality of lens treatment containers to be concurrently moved into the corresponding plurality of air guiding channels, one lens treatment container of the corresponding plurality of lens treatment container into one air guiding channel of the corresponding plurality of air guiding channels. The advantages of the air guiding channels are already discussed above, so that in this regard it is referred to the advantages outlined above.

By providing an elongated web to which the nozzles of the plurality of tubes are all connected in an arrangement corresponding to the arrangement of the air guiding channels of the air flow directing element, it is possible to concurrently displace all nozzles from the standby position to the removal position and back to the standby position by displacing the web with the aid of the actuator that is connected to the web, too. This is a reliable solution for the concurrent displacement of all nozzles which is simple and advantageous from a constructional point of view.

The apparatus may further comprise a corresponding plurality of shutters, one shutter of the corresponding plurality of shutters for one inlet of the plurality of inlets of the exhaust air box. The apparatus may further be configured to concurrently open and close a predetermined number of shutters (one shutter up to all shutters) of the corresponding plurality of shutters. It is thus possible to concurrently remove a predetermined number of lenses from a predetermined number of lens treatment containers. Depending on the power of the vacuum source provided, the predetermined number of shutters can be chosen such that the lenses (if present) are safely removed from the lens treatment containers. By way of example, the apparatus may be configured to concurrently open and close two to four shutters at a time, and thereafter open and close the next two to four shutters. However, any other predetermined number is possible as well.

With respect to the system according to the invention, this system comprises an apparatus according to the invention as described above, as well as a source of negative pressure (a vacuum source) connected to the outlet of the exhaust air box for providing negative pressure (vacuum) to the exhaust air box, and ultimately to the one or more inlets of the exhaust air box. The system further comprises one or more (i.e. at least one) treatment containers for the accommodation of the lens during the lens treatment process. And, finally, the system comprises a transport mechanism for transporting the one or more lens treatment containers to and from the apparatus for the removal of the lens from the one or more lens treatment container. Importantly, the system is configured such that in the apparatus for the removal of the lens from the one or more lens treatment containers, the one or more lens treatment containers are arranged in an air environment. This configuration of the system enables a ‘dry removal’ of the lens from the lens treatment container (that is to say a removal of the lens from the lens treatment container in an air environment, i.e. without the lens being immersed in a liquid).

Such dry removal is advantageous in a number of aspects when compared to a ‘wet removal’ which is generally possible as well using the apparatus according to the invention (i.e. a removal of the lens from the lens treatment container when the lens is immersed in a liquid). However, for dry removal, the vacuum consumption (and thus the energy consumption) is considerably lower than for wet removal. Also, for dry removal the source of negative pressure does not need a sophisticated liquid separator, as this is required for wet removal. Thus, the required source of negative pressure for dry removal is technically much less expensive than for wet removal.

In addition, in wet removal of the lens from a water bath in which it is immersed, the water aspirated together with the lens is classified as being ‘contaminated’ and is not allowed to be returned to the water bath, but must be drained. Thus, for wet removal the water consumption in mass production of lenses is comparatively high, even in case only some tenths of milliliters of water are removed from the lens treatment container together with the lens. For dry removal, it is just ambient air that is sucked in, rendering removal of the lens from the lens treatment container simple from a technical point of view as well as more reliable, as the lens is removed from the lens treatment container by means of a flow of air.

The lens treatment container may comprise a substantially tubular body, and this body has an open end (e.g. the proximal end) which is in fluid communication with an interior space of the body. The body further has openings therein (e.g. at the distal end of the body or in the tubular sidewall, for allowing fluid communication between an exterior of the lens treatment container and the interior space of the body. Such lens treatment container is known in the art, for example from WO 2011/045384, and is advantageous as manufacture thereof using injection molding techniques is simple, reliable and cheap. The nozzle comprises a distal nozzle end that is sized and shaped for introduction into the lens treatment container through the access opening which, as mentioned, may be provided at the proximal end of the lens treatment container. Accordingly, by lowering the nozzle from the standby position into the lens removal position the fluid communication of the nozzle and the interior space of the body of the lens treatment container can be easily established, and by raising the nozzle again into the standby position this fluid communication can be interrupted again in a technically simple manner. At the same time, the air flow through the openings in the body of the lens treatment container reliably carries the lens (if present) along with the air flow and through the access opening of the body into the nozzle, through the inlet of the exhaust air box and—if present—into the lens retainer.

Finally, as regards the method according to the invention, the advantages of the method are already discussed above with respect to the apparatus and system for the removal of the lens from the lens treatment container, and are therefore not reiterated.

These and still further features and advantages of the system, apparatus and method according to the invention will become apparent from the following description of exemplary embodiments, with reference being made to the appended schematic drawings.

### BRIEF DESCRIPTION OF THE DRAWINGS

FIG. 1 is a perspective view of the system according to an embodiment of the invention.

FIG. 2 is a further perspective view of the system of FIG. 1;

FIG. 3 is a top view of the system of FIG. 1;

FIG. 4 shows a side view of a section through the system along line A-A of FIG. 3;

FIG. 5 shows a top view of a section along line B-B of FIG. 4;

FIG. 6 shows detail C of FIG. 4;

FIG. 7 shows a perspective view of details of an air flow directing element of the system of FIG. 1, together with the tubes and nozzles in the lens removal position;

FIG. 8 is a perspective view of the air flow directing element shown in FIG. 7;

FIG. 9 is a perspective cross-sectional view of the system of FIG. 1 (without the vacuum source); and

FIG. 10 is a diagrammatic illustration of an embodiment of the method according to invention.

### DETAILED DESCRIPTION

FIG. 1-FIG. 4 show an embodiment of the system 40 according to the invention in different views.

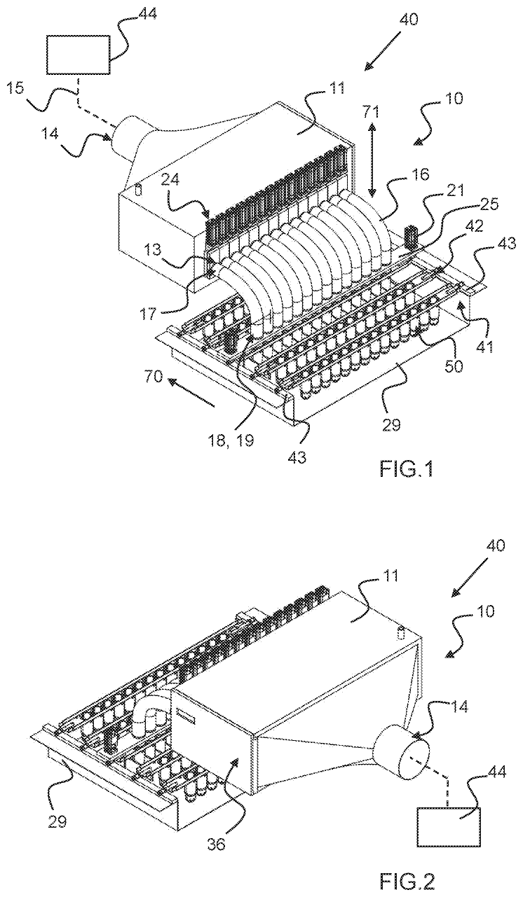

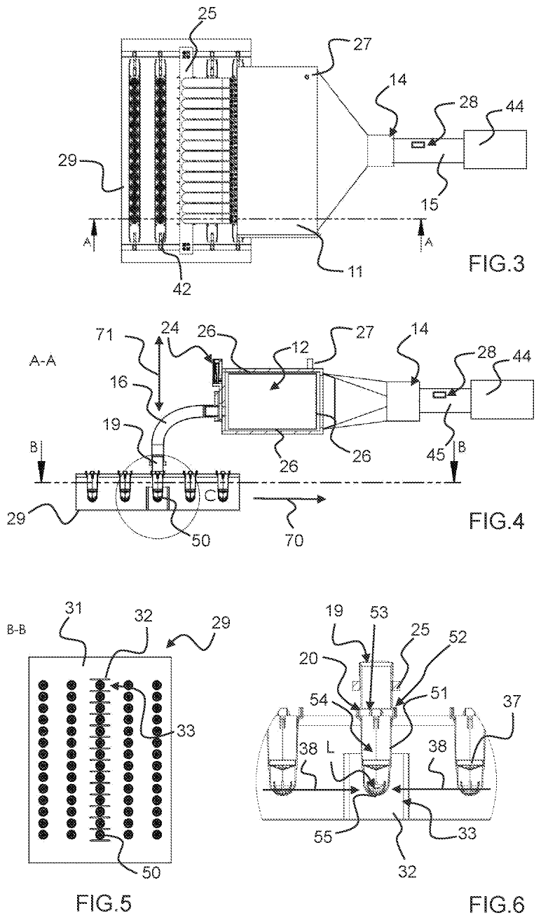

FIG. 1 and FIG. 2 show perspective views of the embodiment of a system 40 according to the invention, which is a system for the removal of an ophthalmic lens, such as a contact lens, for example a soft contact lens, from a lens treatment container 50 for the accommodation of the ophthalmic lens (in the following referred to as ‘lens’) during a lens treatment process. FIG. 3 shows a top view and FIG. 4 shows a sectional side view of the embodiment of the system 40. The system 40 may advantageously be integrated in a contact lens production line (not shown).

The system 40 comprises an apparatus 10 for the removal of the lens from the lens treatment container 50 according to the invention, a source of negative pressure 44, and a transport mechanism 41 for transporting the lens treatment container 50 to and from the apparatus 10. In the apparatus 10, the lens treatment container 50 is arranged in an air environment (to enable dry removal of the lens from the lens treatment container 50).

Apparatus 10 comprises an exhaust air box 11 that may be arranged stationary. Exhaust air box 11 comprises an interior space 12 (see FIG. 4), a plurality of inlets 13 as well as an outlet 14 which is in fluid communication with the interior space 12 of the exhaust air box 14. The source of negative pressure 44 is connected to the outlet 14 through a supply tube 15 (indicated schematically by a dashed line in FIG. 1, see also FIG. 4).

Apparatus 10 further comprises a plurality of flexible tubes 16 (in the embodiment shown fourteen such tubes). Each tube 16 has a proximal end 17 which is connected to to a respective inlet 13 of the plurality of inlets (in the embodiment shown there are fourteen such inlets, and the number of inlets corresponds to the number of flexible tubes). To connect the proximal end 17 of the respective tube 16 to the respective inlet 13, each inlet 13 may be provided with a socket to which the proximal end 17 of the tube 16 can be mounted in a fluid-tight manner. Each tube 16 further comprises a distal end 18 having a (rigid) nozzle 19, and the nozzles 19 of all tubes 16 are fixedly connected to an elongated web 25 of apparatus 10.

Apparatus 10 further comprises an actuator 21 connected to the elongated web 25, so that by linearly displacing the web 25 vertically with the aid of the actuator 21, the nozzles 19 are vertically displaceable from a standby position, in which there is no fluid communication between the nozzle 19 and the respective lens treatment container 50, to a lens removal position in which there is a fluid communication between the nozzle 19 and the respective lens treatment container 50, and back to the standby position. This is indicated in FIG. 1 by double-headed arrow 71, and is explained in more detail below in connection with the mode of operation of the system.

Apparatus 10 further comprises a plurality of shutters 24 corresponding to the number of inlets 13 of the exhaust air box 11, for individually opening and closing each of the inlets 13 of the exhaust air box 11 in order to establish or interrupt a fluid communication with the interior space 12 of the exhaust air box 11. A predetermined number of these shutters 24 may be concurrently opened and closed at a time (for example, two to four shutters can be concurrently opened and closed).

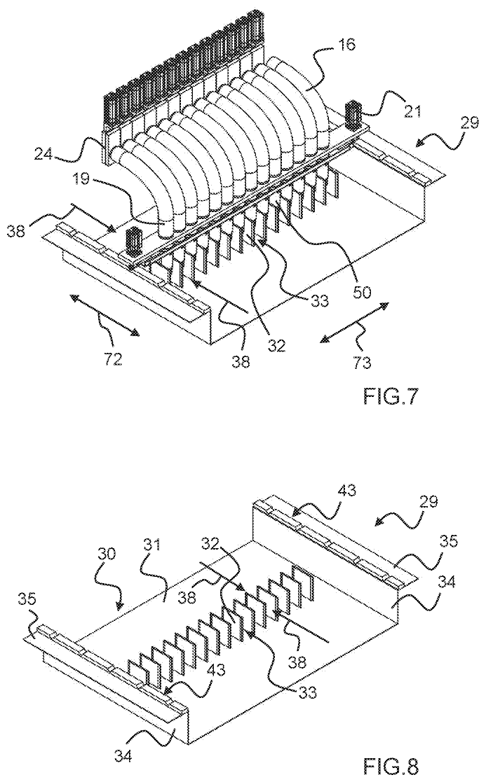

Yet further, the apparatus 10 comprises an air flow directing element 29 which is also shown in FIG. 1 and FIG. 2, but is described in in more detail with reference to FIG. 7 and FIG. 8. The air flow directing element 29 comprises a base plate 30 having an upper surface 31, and a plurality of air directing walls 32, with two adjacently arranged air directing walls 32 forming a pair of air directing walls 32. The base plate 30 is flat and the upper surface thereof is planar. The air directing walls 32 extend away from the upper surface 31 of the base plate 30 in a direction perpendicular to the base plate 30, and are arranged parallel to one another to define an air guiding channel 33 between the air directing walls 32 of each pair. The air directing walls 32 of this embodiment are formed by rectangular plates, and the number of air guiding channels 33 corresponds to the number of tubes 16 (and nozzles 19). The respective air guiding channel 33 is sized to allow one lens treatment container 50 to be moved into the respective air guiding channel 33 for the removal of the ophthalmic lens from the lens treatment container 50. That is, the adjacently arranged air directing walls 32 of a respective pair of air directing walls 32 are spaced from one another by a distance allowing the lens treatment container 50 to be moved into a position between the air guiding walls 32. On the other hand, this distance between the spaced air directing walls 32 of a respective pair of air directing walls 32 is such that once the lens treatment container 50 is arranged between the air directing walls 32 of the respective pair, there is only little (lateral) left between the air directing walls 32 and the lens treatment container 50 (see FIG. 6).

As the air flow directing element 29 comprises a plurality of air guiding walls, a plurality of air guiding channels 33 is formed between them, and the number of air guiding channels 33 corresponds to the number of inlets 13 of the exhaust air box 11 (which in turn corresponds to the number of tubes 16 connected to these inlets 13—in the embodiment shown this number is fourteen), so that a corresponding number (in the embodiment: fourteen) of lens treatment containers 50 may be concurrently moved into the air guiding channels 33.

The air directing walls 32 are aligned in the direction 73 of the width of the air flow directing element 29, and they extend parallel to one another in the direction 72 of the length of the air flow directing element 29. The air flow directing element 29 may be made from any suitable material, such as aluminum, stainless steel, or plastics (see FIG. 7).

The air flow directing element 29 further comprises side walls 34 provided at both lateral ends of base plate 30. The side walls 34 extend upwardly from base plate 30 in a direction perpendicular thereto, and at the upper end of the respective side wall 34 an outwardly extending flange 35 is formed (see FIG. 8).

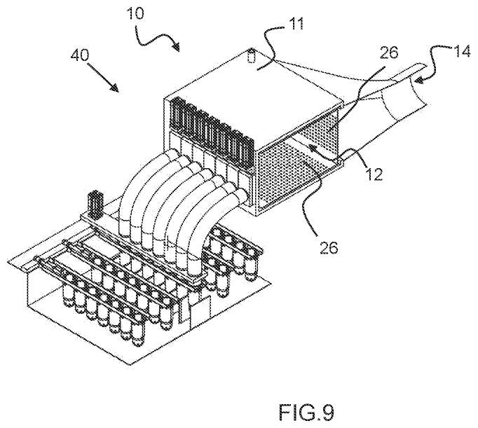

As can be seen best in FIG. 9, the exhaust air box 11 comprises a lens retainer 26 arranged in the interior space 12 of the exhaust air box 11. In the embodiment shown, the lens retainer 26 comprises three perforated metal sheets which are joined together to form a kind of a metal pan. The openings provided in each perforated metal sheet are substantially smaller than the lenses they are supposed to retain. The three perforated metal sheets of lens retainer 26 are sized and shaped to cover the bottom and the top as well as the tapering mouth of the exhaust air box 11 the downstream end of which is connected to the outlet 14 of the exhaust air box 11. Access to the interior space 12 of the exhaust air box 11 is possible by means of a maintenance door 36 which can be opened and closed (see FIG. 2), in order to be able to empty the lens retainer 26 from time to time.

Turning back to FIG. 1, the transport mechanism 41 comprises conveyor belts 43, and these conveyor belts 43 carry a plurality of elongated carrier webs 42. A plurality of lens treatment containers 50 are mounted to each carrier web 42 (in the embodiment shown fourteen such lens treatment containers 50 are mounted to one elongated carrier web 42 along the length of the elongated carrier web 42). By moving the elongated carrier webs 42 to which the lens treatment containers 50 are mounted with the aid of the conveyor belts 43 along the outwardly extending flanges 35 of the air flow directing element 29 (see FIG. 8), the lens treatment containers 50 are transported to and away from the apparatus 10, as is indicated in FIG. 1 by arrow 70.

An embodiment of the lens treatment container 50 is shown in more detail in FIG. 6. The lens treatment container 50 comprises a substantially tubular body 51 having an open end 52 defining an access opening 53. The access opening 53 is is in fluid communication with an interior space 54 of the body 51. The body 51 further has openings 55 therein for allowing fluid communication between an exterior of the lens treatment container 50 and the interior space 54 of the body 51, and a lens retaining membrane-like element 37 having a plurality of flexible triangular fins to retain a lens L within the lens treatment container 50 as the lens treatment container 50 is moved through a plurality of liquid treatment baths. Such a lens treatment container 50 is generally known and is described, for example, in WO 2011/045384.

As can further be seen in FIG. 6, the nozzle 19 comprises a distal nozzle end 20 that is sized and shaped for introduction into the lens treatment container 50 through the access opening 53 to establish a fluid communication between the nozzle 19 and the interior space 54 of the body 51.

Operation of the embodiment of the system 40 and apparatus 10 according to the invention is described in the following. The source of negative pressure 44 provides negative pressure (vacuum) to the interior space 12 of exhaust air box 11 through the supply tube 15 connected to the outlet 14 of exhaust air box 11. The shutters 24 are all closed, so that once the desired negative pressure (vacuum) is established in the interior space 12 of exhaust air box 11 (this can be determined with the aid of vacuum gauge 27, see FIG. 3 and FIG. 4) there is practically no flow (or only a predetermined small leakage flow) of air through the supply tube 15. This can be determined with the aid of the pitot pipe sensor 28.

The elongated web 25 to which the nozzles 19 are (rigidly) mounted are arranged in the standby position, with the nozzles 19 being arranged in the elongated web 25 in an arrangement corresponding to the arrangement of the air guiding channels 33 of the air flow directing element 29 (see FIG. 7). In this standby position of the web 25 and thus of the nozzles 19, the distal end 20 of each of the nozzles 19 is arranged at a distance above the open end 52 of the respective lens treatment container 50 so that no fluid communication is possible between the nozzle 19 and the interior space of the body 51 of lens treatment container 50.

Next, with the aid of the conveyor belts 43 (FIG. 1) a carrier web 42 with the lens treatment containers 50 mounted thereto is moved to a position in which the lens treatment containers 50 are arranged underneath the nozzles 19 mounted to the elongated web 25. During this movement, each of the lens treatment containers 50 enters the air guiding channel 33 defined by the respective pair of air directing walls 32 of the air flow directing element 29. This is schematically shown in FIG. 5. It is further evident from FIG. 5 that there is only very little (lateral) space left between each lens treatment container 50 and the respective pair of air directing walls 32 of the air flow directing element 29. In this position in which the lens treatment containers 50 are arranged underneath the nozzles 19 and between the respective pairs of air directing walls 32, movement of the conveyor belts 43 is interrupted.

In the following, removal of a lens L contained in the lens treatment container 50 (see FIG. 6) is described, although the same operation is performed in case no lens L is contained in the lens treatment container 50. First, the elongated web 52 and thus the nozzles 19 are moved from the standby position down to a lens removal position (see double-headed arrow 71 in FIG. 4). In this lens removal position, the distal end 20 of the nozzle 19 projects into the open end 52 of the lens treatment container 50 to establish a fluid communication between the nozzle 19 and the interior space of the body 51 of lens treatment container 50 where the lens L is contained. This holds for all nozzles 19 mounted to the elongated web 25 and for all lens treatment containers 50 mounted to carrier web 42.

Next, a predetermined number of the shutters 24 are concurrently opened. For example, four shutters 24 are concurrently opened for a predetermined duration, e.g. for one second. By opening the four shutters 24, the negative pressure in the interior space 12 of the exhaust air box 11 generates suction at the corresponding four nozzles 19. As a consequence, an air flow is generated by ambient air being sucked in through the openings 55 in the body 51 of the respective lens treatment container 50. This air flow continues through the interior space 54 of the body 51 of the respective lens treatment container 50 and bends the flexible fins of the retaining membrane 37 upwards. The lens L is entrained by this air flow, and thus the lens L is removed from the respective lens treatment container 50 through the access opening 53 at the open (proximal) end 52 of the lens treatment container 50 and enters the nozzle 19. From there, the lens L is further entrained by the air flow that flows through the flexible tube 16 and through the inlets 13 into the interior space 12 of exhaust air box 11. In the interior space 12 of the exhaust air box 11 the lens L is retained by the metal sheets of the lens retainer 26 so that the lens L is not further entrained by the air flow that continues to flow through the outlet 14 and the supply tube 15 to the source of negative pressure 44.

After the predetermined duration (e.g. the afore-mentioned one second) has elapsed, the predetermined number of shutters 24 are concurrently closed again, whereupon the air flow is terminated. Thereafter, the next predetermined number of shutters 24 is opened, and the lenses (if any) contained in the lens treatment containers 50 are removed from the lens treatment containers 50 in the manner described above. This is repeated until all shutters 24 have been opened, the lenses (if any) removed, and the shutters 24 closed again.

As the lens treatment containers 50 are arranged in the air guiding channels 33 of the air flow directing element 29, and since there is only little (lateral) space between the air directing walls 32 and the lens treatment container 50 (see FIG. 6), the air sucked in into the body 51 of the lens treatment container 50 through the openings 55 flows essentially only in the directions indicated by the arrows 38 shown in FIG. 6-FIG. 8. This directed air flow leads to a significant improvement of the removal of the lens L from the lens treatment container 50 which is advantageous as compared to a scenario in which air is allowed to enter the interior space 54 of the body 51 of the lens treatment container from all directions (i.e. without directed air flow). Also, the removal of the lenses L from the lens treatment containers 50 in an air environment (‘dry removal’) is advantageous as regards energy consumption when compared to a removal of the lenses L in a liquid environment (‘wet removal’) in which much more energy is required (the vacuum must be significantly stronger as it must be sufficiently strong to transport the liquid and the lens away) and in which a more sophisticated liquid separator is needed to protect the source of negative pressure 44.

Once all shutters 24 have been opened and closed again and the lenses L (if any) have been removed from the lens treatment containers 50, the elongated web 25 is moved upward again back into the standby position. The conveyor belts 43 then move the carrier web 42 with the lens treatment containers 50, from which the lenses L (if any) have been removed, away from the position underneath the elongated web 25 in the direction of the arrow 70 (FIG. 1) and away from the apparatus 10. Concurrently, the conveyor belts 43 move the next carrier web 42 into the position underneath the carrier web 52. Thereafter, removal of the lenses L (if any) from the lens treatment containers 50 now positioned underneath the nozzles 19 connected to the web 25 is performed in the same manner as described above.

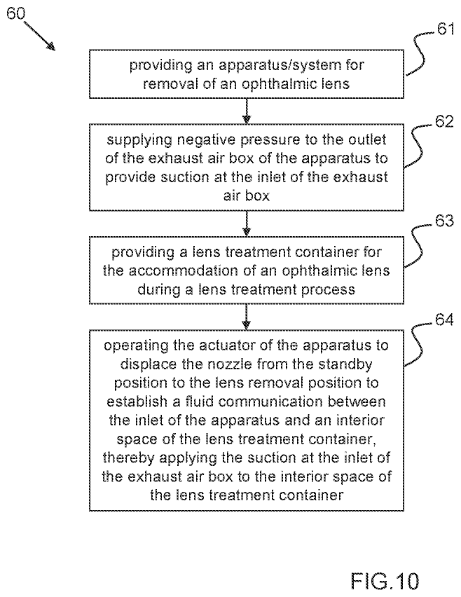

Finally, an embodiment of the method according to the invention is described with the aid of the schematic flow diagram shown in FIG. 10. The method is a method for the removal of an ophthalmic lens, such as a contact lens, for example a soft contact lens, from a lens treatment container 50 for the accommodation of the ophthalmic lens during a lens treatment process. The method 60 comprises: a step 61 of providing an apparatus 10 or a system 40 for the removal of an ophthalmic lens according to the invention; a step 62 of supplying negative pressure to the outlet 14 of the exhaust air box 11 of the apparatus 10 to provide suction at the inlet 13 of the exhaust air box 11; a step 63 of providing a lens treatment container 50 for the accommodation of an ophthalmic lens L during a lens treatment process; a step 64 of operating the actuator 21 of the apparatus 10 to displace the nozzle 19 from the standby position to the lens removal position to establish a fluid communication between the inlet 13 of the apparatus 10 and an interior space 54 of the lens treatment container 50, thereby applying the suction at the inlet 13 of the exhaust air box 11 to the interior space 54 of the lens treatment container 50.

Embodiments of the apparatus, the system, and the method have been described with the aid of the drawings. However, many changes and modifications are possible without departing from the teaching of the invention. Therefore, the scope of protection is not limited to the embodiments described, but is defined by the appended claims.

1. Apparatus (10) for removal of an ophthalmic lens (L) from a lens treatment container (50) for the accommodation of the ophthalmic lens (L) during a lens treatment process, the apparatus (10) comprising:
an exhaust air box (11) comprising
at least one inlet (13) for allowing ambient air to be drawn into the exhaust box (11);
an outlet (14) in fluid communication with the exhaust air box (11), the outlet (14) capable of being connected to a source of negative pressure (44);
at least one tube (16) having a proximal end connected to the at least one inlet (13) of the exhaust air box, and a distal end having a displaceable nozzle (19); and
an actuator (21) connected to the nozzle (19), for displacing the nozzle (19) from a standby position to a lens removal position, and back to the standby position.

2. The apparatus according to claim 1, wherein the exhaust air box (11) further comprises a shutter (24) configured to open or close the at least one inlet (12) of the exhaust air box (11) to establish or interrupt a fluid communication between the nozzle (19) and the exhaust air box (11).

3. The apparatus according to claim 1, wherein the exhaust air box (11) comprises a lens retainer (26) arranged in an interior space (12) of the exhaust air box (11).

4. The apparatus according to claim 1, wherein the apparatus further comprises
a supply tube (15) connected to the outlet (14) of the exhaust air box (11) and capable of being connected to the source of negative pressure (44), and
a pitot pipe sensor (28) arranged in the supply tube (15) for determining a flow of exhaust air through the supply tube (15).

5. The apparatus according to claim 1, wherein the exhaust air box (11) further comprises a vacuum gauge (27) arranged in fluid communication with an interior space (12) of the exhaust air box (11), for determining a negative pressure in the interior space (12) of the exhaust air box (11).

6. The apparatus according to claim 1, wherein the at least one tube (16) is a flexible tube.

7. The apparatus according to claim 1, further comprising an air flow directing element (29), the air flow directing element (29) comprising:
a base plate (30) having an upper surface (31),
at least one pair of air directing walls (32), the air directing walls (32) extending away from the upper surface (31) of the base plate (30) in a direction perpendicular thereto and being arranged parallel to one another to define an air guiding channel (33) therebetween which is sized to allow a lens treatment container (50) to be moved into the air guiding channel (33) for the removal of the ophthalmic lens (L) from the lens treatment container (50).

8. The apparatus according to claim 7, wherein the exhaust air box (11) comprises a plurality of inlets (13), and wherein the apparatus comprises a corresponding plurality of tubes (16), with each tube (16) of the corresponding plurality of tubes (16) being connected to a respective inlet (13) of the plurality of inlets (13) of the exhaust air box (11), and wherein further the air flow directing element (29) comprises a corresponding plurality of air guiding channels (33) being arranged parallel to one another to allow a corresponding plurality of lens treatment containers (50) to be concurrently moved into the corresponding plurality of air guiding channels (33), one lens treatment container (50) of the corresponding plurality of lens treatment containers (50) into one air guiding channel (33) of the corresponding plurality of air guiding channels (33).

9. The apparatus according to claim 8, further comprising an elongated web (25), wherein the nozzles (19) of the plurality of tubes (16) are all connected to the web (25) in an arrangement corresponding to the arrangement of the air guiding channels (33) of the air flow directing element (29), and wherein the actuator (21) is connected to the web (25) for displacing the web (25) to concurrently displace all nozzles (19) from the standby position to the lens removal position, and back to the standby position.

10. The apparatus according to claim 8, further comprising a corresponding plurality of shutters (24), one shutter (24) of the corresponding plurality of shutters (24) for one inlet (13) of the plurality of inlets (13) of the exhaust air box (11), wherein the apparatus is further configured to concurrently open and close a predetermined number of shutters (24) of the corresponding plurality of shutters (24) to open and close a corresponding predetermined number of inlets (13) of the plurality of inlets (13) of the exhaust air box (11).

11. A system (40) for removal of an ophthalmic lens (L) from a lens treatment container (50) for the accommodation of the ophthalmic lens (L) during a lens treatment process, the system comprising:
an apparatus (10) according to claim 1 for removal of an ophthalmic lens (L) from the lens treatment container (50);
a source of negative pressure (44) connected to the outlet (14) of the exhaust air box (11);
at least one lens treatment container (50) for the accommodation of an ophthalmic lens (L) during a lens treatment process; and
a transport mechanism (41) for transporting the at least one lens treatment container (50) to and from the apparatus (10) for the removal of the ophthalmic lens (L) from the at least one lens treatment container (50), wherein the system (40) is configured such that in the apparatus (10) for the removal of the ophthalmic lens (L) from the lens treatment container (50) the at least one lens treatment container (50) is arranged in an air environment.

12. The system according to claim 11, wherein the at least one lens treatment container (50) comprises a substantially tubular body (51), the body (51) having an open end (52) defining an access opening (53) which is in fluid communication with an interior space (54) of the body (51), and the body (51) further having openings (55) therein for allowing fluid communication between an exterior of the lens treatment container (50) and the interior space (54) of the body (51), and wherein the nozzle (19) comprises a distal nozzle end (20) sized and shaped for introduction into the lens treatment container (50) through the access opening (53) to establish a fluid communication of the nozzle (19) and the interior space (54) of the body (51).

13. A method (60) for removal of an ophthalmic lens (L) from a lens treatment container (50) for the accommodation of the ophthalmic lens (L) during a lens treatment process, the method comprising:
providing an apparatus (10) for removal of an ophthalmic lens (L) according to claim 1;
supplying negative pressure to the outlet (14) of the exhaust air box (11) of the apparatus (10) to provide suction at the inlet (13) of the exhaust air box (11);
providing a lens treatment container (50) for the accommodation of an ophthalmic lens (L) during a lens treatment process; and
operating the actuator (21) of the apparatus (10) to displace the nozzle (19) from the standby position to the lens removal position to establish a fluid communication between the inlet (13) of the apparatus (10) and an interior space (54) of the lens treatment container (50), thereby applying the suction at the inlet (13) of the exhaust air box (11) to the interior space (54) of the lens treatment container (50).
